(19) United States
(12) Patent Application Publication
(10) Pub. No.: US 2024/0228839 A1
(43) Pub. Date: Jul. 11, 2024

(54) TWO-COMPONENT THERMALLY CONDUCTIVE ADHESIVE COMPOSITION AND TWO-COMPONENT THERMALLY CONDUCTIVE GAP-FILLING GLUE

(71) Applicant: 3M INNOVATIVE PROPERTIES COMPANY, St. Paul, MN (US)

(72) Inventors: Lingjie Tong, Shanghai (CN); Xiaohai Sheng, Shanghai (CN); Ahmad Shaaban, Xöln (DE)

(21) Appl. No.: 18/002,113

(22) PCT Filed: Jun. 16, 2021
(86) PCT No.: PCT/IB2021/055327

§ 371 Date: Dec. 16, 2022

(30) Foreign Application Priority Data
Jul. 8, 2020 (CN) 202010654178.3

(51) Int. Cl. C09J 133/08; C09J 4/06; C09J 11/04; C09J 11/06

(52) U.S. Cl. CPC C09J 133/08; C09J 4/06; C09J 11/04; C09J 11/06

(57) ABSTRACT

The present invention provides a two-component thermally conductive adhesive composition and a two-component thermally conductive gap-filling glue. The composition comprises: 8-38 wt % of an acrylate monomer or a combination of an acrylate monomer and an acrylate oligomer, with a glass transition temperature ranging from −80° C. to −10° C.: 0.2-4 wt % of a peroxide oxidant: 0.05-1 wt % of a peroxide decomposition promoter; and 60-90 wt % of a thermally conductive filler, wherein the two-component thermally conductive adhesive composition comprises Part A and Part B. Part A comprises a peroxide oxidant and Part B comprises a peroxide decomposition promoter: the acrylate monomer, or the combination of the acrylate monomer and the acrylate oligomer, and the thermally conductive filler exist in one or both of Part A and Part B. The products of the two-component thermally conductive adhesive composition and the two-component thermally conductive gap-filling glue after curing have a high elongation-at-break, high thermal conductivity and low bonding strength to aluminum metal surfaces, and are suitable for use as a thermally conductive gap-filling material in the battery pack module of an electro-mobile.

### TECHNICAL FIELD

The present invention relates to the technical field of gap-filling materials for battery pack modules of electric vehicles. In particular, the present invention provides a two-component thermally conductive adhesive composition and a two-component thermally conductive gap-filling glue.

### BACKGROUND

In order to provide insulation, heat conduction, waterproofing, and shock-proofing properties to electrical elements (such as battery packs of electric vehicles and consumer electrical elements), gap-filling and grouting treatments are usually performed on the electrical elements with materials such as epoxy resins and organosilicon resins. In particular, organosilicon adhesives with good thermal and mechanical performance are generally employed in the art to achieve adhesion between battery pack modules in electric vehicles. However, the curing process of the current organosilicon adhesives is typically slow, requiring about 12-24 hours to achieve the desired adhesion strength. In addition, silicone contained in the organosilicon adhesive formula poses the risk of causing short circuits in the battery pack during long-term use. Additionally, the gap-filling material used to fill battery packs of automobiles ought to have good removability to facilitate the later maintenance and replacement of automobile batteries.

Therefore, it is of great significance to develop a gap-filling glue that cures quickly and creates a cured product with a high elongation-at-break, high thermal conductivity, and low bonding strength to aluminum metal surfaces.

### SUMMARY

In view of the technical problems illustrated above, the present invention aims to provide a two-component thermally conductive adhesive composition and a two-component thermally conductive gap-filling glue comprising the same. The products of the two-component thermally conductive adhesive composition and the two-component thermally conductive gap-filling glue after curing have a high elongation-at-break, high thermal conductivity and low bonding strength to aluminum metal surfaces, and are suitable for use as a thermally conductive gap-filling material in battery pack modules of electric vehicles.

The inventors have conducted intensive and detailed research to obtain the present invention.

According to one aspect of the present invention, there is provided a two-component thermally conductive adhesive composition, based on the weight of the two-component thermally conductive adhesive composition as 100 wt %, comprising:
8-38 wt % of an acrylate monomer or a combination of an acrylate monomer and an acrylate oligomer, with a glass transition temperature ranging from −80° C. to −10° C.;
0.2-4 wt % of a peroxide oxidant;
0.05-1 wt % of a peroxide decomposition promoter; and
60-90 wt % of a thermally conductive filler, wherein
the two-component thermally conductive adhesive composition comprises Part A and Part B: the Part A comprises the peroxide oxidant and the Part B comprises the peroxide decomposition promoter: the acrylate monomer, or the combination of the acrylate monomer and the acrylate oligomer, and the thermally conductive filler exist in one or both of the Part A and Part B.

According to another aspect of the present invention, there is provided a two-component thermally conductive gap-filling glue, comprising the above two-component thermally conductive adhesive composition.

Compared with the prior art in the art, the present invention has the following advantages: the products of the two-component thermally conductive adhesive composition and the two-component thermally conductive gap-filling glue after curing according to the technical solutions of the present invention have a high elongation-at-break, high thermal conductivity and low bonding strength to aluminum metal surfaces, and are suitable as a thermally conductive gap-filling material in battery pack modules of electric vehicles.

### DETAILED DESCRIPTION

It is to be understood that those of skill in the art can envisage other various embodiments according to teachings in this description and can make modifications thereto without departing from the scope or spirit of the present disclosure. Therefore, the following particular embodiments have no limiting meaning.

All figures for denoting characteristic dimensions, quantities and physicochemical properties used in this specification and claims are to be understood as modified by a term “about” in all situations, unless indicated otherwise. Therefore, unless stated conversely, parameters in numerical values listed in the above description and the claims are all approximate values, and those of skill in the art are capable of seeking to obtain desired properties by taking advantage of contents of the teachings disclosed herein, and changing these approximate values appropriately. The use of a numerical range represented by end points includes all figures within the range and any range within the range, for example, 1 to 5 includes 1, 1.1, 1.3, 1.5, 2, 2.75, 3, 3.80, 4, 5, and the like.

In current disclosure, the term “average particle diameter” refers to Dv50, which means volume D50. Dv50 is also known as volume median or volume average particle size, it physically represents that each volume of particles greater or smaller than such value takes account of 50% of the total particles volume. Dv50 is determined by using laser granulometry.

The term “glass transition temperature” or “Tg” refers to the temperature at which a material changes from a glassy state to a rubbery state. In this context, the term “glassy” means that the material is hard and brittle (and therefore relatively easy to break) while the term “rubbery” means that the material is elastic and flexible. For polymeric materials the Tg is the critical temperature that separates their glassy and rubbery behaviors. If a polymeric material is at a temperature below its Tg, large-scale molecular motion is severely restricted because the material is essentially frozen. On the other hand, if the polymeric material is at a temperature above its Tg, molecular motion on the scale of its repeat unit takes place, allowing it to be soft or rubbery. The glass transition temperature of a polymeric material is often determined using methods such as Differential Scanning calorimetry or can be calculated through the FOX equation. Any reference herein to the Tg of a monomer or a oligomer refers to the Tg of the corresponding homopolymer.

The FOX equation is an equation used to describe the relationship between Tg of a copolymer and Tg of a homopolymer constituting the component of the copolymer. For example, for a copolymer constituted by monomer units A, B, C and the like, Tg thereof can be represented by following formula:

$$\frac{1}{T g} = \frac{{W}_{A}}{T {g}_{A}} + \frac{{W}_{B}}{T {g}_{B}} + \frac{{W}_{C}}{T {g}_{C}} + …$$

wherein
Tg is Tg of the copolymer:
W_{A}, W_{B} and W_{C} are the mass percentage of the monomer units A, B and C respectively:
Tg_{A}, Tg_{B}. Tg_{C} and the like are Tg of homopolymer A, homopolymer B, homopolymer C and the like respectively.

The present inventors discovered the following in the study: when a specific amount of an acrylate monomer or a combination of an acrylate monomers and an acrylate oligomer with a specific glass transition temperature (i.e., in the range of −80° C. to −10° C.) is employed as the adhesive matrix and particular types and specific contents of other components in the adhesive are controlled, the product of the prepared thermally conductive adhesive after curing has a high elongation-at-break, high thermal conductivity and low bonding strength to aluminum metal surfaces.

In particular, according to one aspect of the present invention, there is provided a two-component thermally conductive adhesive composition, based on the weight of the two-component thermally conductive adhesive composition as 100 wt %, comprising:
8-38 wt % of an acrylate monomer or a combination of an acrylate monomer and an acrylate oligomer, with a glass transition temperature ranging from −80° C. to −10° C.;
0.2-4 wt % of a peroxide oxidant;
0.05-1 wt % of a peroxide decomposition promoter; and
60-90 wt % of a thermally conductive filler, wherein
the two-component thermally conductive adhesive composition comprises Part A and Part B; the Part A comprises the peroxide oxidant and the Part B comprises the peroxide decomposition promoter: the acrylate monomer, or the combination of the acrylate monomer, and the acrylate oligomer, and the thermally conductive filler exist in one or both of the Part A and Part B.

According to certain specific embodiments of the present invention, acrylate monomer or the combination of the acrylate monomer and the acrylate oligomer is employed as the basic material for the two-component thermally conductive adhesive composition. Acrylic resin adhesives prepared from the acrylate monomer or the combination of the acrylate monomer and the acrylate oligomer possess good durability, environmental friendliness, and the like. The acrylate monomer or the combination of the acrylate monomer and the acrylate oligomer may optionally exist in one or both of the Part A and Part B. Particular examples of the acrylate monomer that can be used in the present invention are not particularly limited so long as the glass transition temperature of the acrylate monomer is in the range of −80° C. to −10° C. Preferably, the acrylate monomer is an acrylate monomer having 7-27 carbon atoms, and preferably 8-21 carbon atoms. More preferably, the acrylate monomer is selected from the group consisting of heptadecyl acrylate, tetrahydrofuran acrylate, lauryl methacrylate, isodecyl acrylate, octyl acrylate, isooctyl acrylate, tridecyl acrylate, dodecyl acrylate, dodecyl methacrylate, methoxypolyethylene glycol monomethacrylate, methoxypolyethylene glycol monoacrylate, alkoxydodecyl acrylate, 2-(2-ethoxyethoxy)ethyl acrylate, tetrahydrofuran alkoxide acrylate, or a combination thereof. Particular examples of the acrylate oligomer that can be used in the present invention are not particularly limited so long as the glass transition temperature of the acrylate oligomer is in the range of −80° C. to −10° C., or −54° C. to −3ºC, or −60° ° C. to −40° C. Preferably, the acrylate oligomer is an aliphatic urethane acrylate oligomer. Preferably, the number average molecular weight of the aliphatic urethane acrylate oligomer ranges from 5,000 g/mol to 8,000 g/mol.

In order to further increase the softness and elongation-at-break of the cured product obtained by curing the two-component thermally conductive adhesive composition, preferably, the acrylate monomer and the acrylate oligomer with a glass transition temperature ranging from −80° ° C. to −10° C. are an acrylate monomer and an acrylate oligomer having no aryl group (e.g., phenyl, etc.) in the molecule. The presence of aryl (e.g., phenyl, etc.) in the molecule will increase the glass transition temperature of the acrylate material and thereby reduce the elongation-at-break.

Based on the weight of the two-component thermally conductive adhesive composition as 100 wt %, the two-component thermally conductive adhesive composition comprises 8-38 wt % and preferably 20-38 wt % of an acrylate monomer or a combination of an acrylate monomer and an acrylate oligomer, with a glass transition temperature ranging from −80° C. to −10° C.

Commercially available examples of the acrylate monomer that can be used in the present invention include C17A (heptadecyl acrylate) produced by BASF Corporation, having a glass transition temperature of −72° C.; and SR285 (tetrahydrofuran acrylate) produced by Sartomer Corporation, having a glass transition temperature of −15° C. In addition, commercially available examples of the acrylate oligomer that can be used in the present invention include: CN8888 (an aliphatic polyurethane acrylate oligomer) produced by Sartomer Corporation, having a number average molecular weight of 6,000 g/mol-8,000 g/mol and a glass transition temperature of −32° ° C.: and CN9021 (an aliphatic polyurethane acrylate oligomer) produced by Sartomer Corporation, having a number average molecular weight of 5,000 g/mol-6,000 g/mol and a glass transition temperature of −54° C.

The two-component thermally conductive adhesive composition according to the present invention comprises a peroxide oxidant. During use, free radicals are generated by a redox reaction between the peroxide oxidant and the peroxide decomposition promoter, and the free radicals initiate crosslinking reaction of the acrylate monomer or the combination of the acrylate monomer and the acrylate oligomer with a glass transition temperature ranging from −80° C. to −10° C., to promote the curing of the two-component thermally conductive adhesive composition. The particular type of the peroxide oxidant that can be used in the present invention is not particularly limited, and the peroxide oxidant may be selected from the oxidants commonly used for crosslinking acrylate monomers in the art. Preferably, the peroxide oxidant is one or more peroxide oxidants selected from the group consisting of hydroperoxide oxidants, ketone peroxide oxidants, and diacyl peroxide oxidants. Particularly, the hydroperoxide oxidant includes: tert-butyl hydroperoxide, cumene hydroperoxide, isopropylbenzene hydroperoxide, 2,5-dimethylhexane-2,5-dihydrogenperoxide and 1,1,3,3-tetramethylbutyl hydroperoxide, and the like. Particularly, the ketone oxidant includes: methyl ethyl ketone peroxide, cyclohexanone peroxide, 3,3,5-trimethyl cyclohexanone peroxide, methyl cyclohexanone peroxide, methyl acetoacetate peroxide, acetylacetone peroxide, and the like. The diacyl peroxide oxidant includes: benzoyl peroxide, acetyl peroxide, isobutyl peroxide, octanoyl peroxide, decanoyl peroxide, lauroyl peroxide, 3,3,5-trimethylhexanoyl peroxide, succinic peroxide, benzoyl peroxide, 2,4-dichlorobenzoyl peroxide and m-toluoyl peroxide, and the like. One or more of these peroxides may be used.

Based on the weight of the two-component thermally conductive adhesive composition as 100 wt %, the two-component thermally conductive adhesive composition comprises 0.2-4 wt % and preferably 0.5-1 wt % of a peroxide oxidant. If the amount of the peroxide oxidant in the two-component thermally conductive adhesive composition is less than 0.2 wt %, the adhesive will undercure and not have sufficient adhesiveness during use. If the amount of the peroxide oxidant in the two-component thermally conductive adhesive composition is greater than 4 wt %, the cured product will have decreased adhesiveness and reduced stability.

In order to promote the effective decomposition of the peroxide oxidant to accelerate crosslinking and curing of the acrylate monomer or the combination of the acrylate monomer and the acrylate oligomer, the two-component thermally conductive adhesive composition according to the present invention further comprises at least one peroxide decomposition promoter. Preferably, when a hydroperoxide oxidant or a ketone peroxide oxidant is employed as the peroxide oxidant, the peroxide decomposition promoter is one or more peroxide decomposition promoters selected from the group consisting of an organic acid metal salt peroxide decomposition promoter, an organometallic chelate peroxide decomposition promoter, a thiourea peroxide decomposition promoter. The organic acid metal salt peroxide decomposition promoter and the organometallic chelate peroxide decomposition promoter include: cobalt naphthenate, copper naphthenate, manganese naphthenate, cobalt octoate, copper octoate, manganese octoate, copper acetylacetonate, titanium acetylacetonate, manganese acetylacetonate, chromium acetylacetonate, iron acetylacetonate, vanadium acetylacetonate, cobalt acetylacetonate, and the like. Additionally, when a diacyl peroxide oxidant is employed as the peroxide oxidant, the peroxide decomposition promoter is an amine peroxide decomposition promoter. Particularly, the amine peroxide decomposition promoters include: N,N-dimethyl-p-toluidine, N,N-diethyl-p-toluidine, N,N-di(2-hydroxyethyl)-p-toluidine, N,N-diisopropanol-p-toluidine, triethylamine, tripropylamine, ethyl diethanolamine, N,N-dimethylaniline, ethylene diamine, triethanolamine, aldehyde-amine condensation reactants, and the 30) like. Decomposition promoters of one, two or more of these organic oxides may be used.

Based on the weight of the two-component thermally conductive adhesive composition as 100 wt %, the two-component thermally conductive adhesive composition comprises 0.05 to 1 wt %, preferably 0.1 to 1 wt %, of a peroxide decomposition promoter. If the amount of the peroxide decomposition promoter in the two-component thermally conductive adhesive composition is less than 0.05 wt %, the adhesive will undercure and not have sufficient adhesiveness during use. If the amount of the peroxide decomposition promoter in the two-component thermally conductive adhesive composition is greater than 1 wt %, the cured product will have decreased adhesiveness and reduced stability.

According to the technical solution of present invention, in order to avoid premature curing of the two-component thermally conductive adhesive composition, the peroxide oxidant exists in the Part A, and the peroxide decomposition promoter exists in the Part B. Preferably, the Part A and the Part B are contained in the two-component cure composition as two separate parts.

The cured glue formed by curing the two-component thermally conductive adhesive composition or the two-component thermally conductive gap-filling glue according to the present invention is required to have good thermal conductivity to be used for gap-filling of battery pack modules. Thus, the two-component thermally conductive adhesive composition comprises a thermally conductive filler. The particular type of the thermally conductive filler that can be used in the present invention is not particularly limited, and the thermally conductive filler may be conventionally selected from thermally conductive materials for electronic elements. Preferably, the thermally conductive filler is an inorganic thermally conductive filler. More preferably, the inorganic thermally conductive filler is one or more compounds selected from the group consisting of aluminum hydroxide, aluminum oxide, aluminum nitride, and boron nitride. Preferably, the inorganic thermally conductive filler has an average particle diameter (Dv50) ranging from 1 to 130 μm. Based on the weight of the two-component thermally conductive adhesive composition as 100 wt %, the two-component thermally conductive adhesive composition comprises 60-90 wt % of a thermally conductive filler. If the amount of the thermally conductive filler is less than 60 wt %, sufficient thermal conductivity cannot be imparted to the cured product. If the amount of the thermally conductive filler is greater than 90 wt %, the cured product will have decreased adhesiveness and deteriorated elongation-at-break and cannot be used as a thermally conductive adhesive gap-filling material.

According to certain preferred embodiments of the present invention, in order to promote the efficiency of mixing Part A with Part B during use to improve the applicability thereof, preferably the acrylate monomer, or the combination of the acrylate monomer and the acrylate oligomer, and the thermally conductive filler exist in the Part A and the Part B at the same time. Preferably, the mass ratio of the Part A to the Part B is in the range of 1:10-10:1, preferably 1:4-4: 1. Most preferably, the mass ratio of the Part A to the Part B is 1:1.

There is no particular limitation on the preparation method of the two-component thermally conductive adhesive composition, which may be prepared by simple mixing. Specifically, the two-component thermally conductive adhesive composition obtained by mixing comprises Part A and Part B that are separate, where the Part A comprises a peroxide oxidant and the Part B comprises a peroxide decomposition promoter: the acrylate monomer, or the combination of the acrylate monomer and the acrylate oligomer, and the thermally conductive filler exist in one or both of the Part A and Part B.

In the two-component thermally conductive adhesive composition according to the present invention, one or more other additives may also be comprised to impart one or more additional desired properties, provided that the objective of the present invention is not harmed. For example, a stabilizer such as hydroquinone and 2,6-di-tert-butyl-p-cresol can be added to the Part A containing the peroxide oxidant.

According to another aspect of the present invention, there is provided a two-component thermally conductive gap-filling glue, comprising the above two-component thermally conductive adhesive composition.

Various exemplary embodiments of the present invention are further described by a list of embodiments below, which should not be construed as unduly limiting the present invention:

Specific embodiment 1 is a two-component thermally conductive adhesive composition. Based on the weight of the two-component thermally conductive adhesive composition as 100 wt %, the two-component thermally conductive adhesive composition comprising:
8-38 wt % of an acrylate monomer or a combination of an acrylate monomer and an acrylate oligomer, with a glass transition temperature ranging from −80° C. to −10° C.;
0.2-4 wt % of a peroxide oxidant;
0.05-1 wt % of a peroxide decomposition promoter; and
60-90 wt % of a thermally conductive filler, where
the two-component thermally conductive adhesive composition comprises Part A and Part B, the Part A comprises the peroxide oxidant and the Part B comprises the peroxide decomposition promoter, and the acrylate monomer or the combination of the acrylate monomer and the acrylate oligomer, and the thermally conductive filler exist in one or both of the Part A and Part B.

Specific embodiment 2 is the two-component thermally conductive adhesive composition according to Embodiment 1, where the acrylate monomer is an acrylate monomer having 7-27 carbon atoms.

Specific embodiment 3 is the two-component thermally conductive adhesive composition according to Embodiment 1, where the acrylate monomer is selected from the group consisting of heptadecyl acrylate, tetrahydrofuran acrylate, lauryl methacrylate, isodecyl acrylate, octyl acrylate, isooctyl acrylate, tridecyl acrylate, dodecyl acrylate, dodecyl methacrylate, methoxypolyethylene glycol monomethacrylate, methoxypolyethylene glycol monoacrylate, alkoxydodecyl acrylate, 2-(2-ethoxyethoxy)ethyl acrylate, tetrahydrofuran alkoxide acrylate, or a combination thereof.

Specific embodiment 4 is the two-component thermally conductive adhesive composition according to Embodiment 1, where the acrylate oligomer is an aliphatic urethane acrylate oligomer.

Specific embodiment 5 is the two-component thermally conductive adhesive composition according to Embodiment 4, where the number average molecular weight of the aliphatic urethane acrylate oligomer is in the range of 5,000 g/mol to 8,000 g/mol.

Specific embodiment 6 is the two-component thermally conductive adhesive composition according to Embodiment 1, where the peroxide oxidant is one or more peroxide oxidants selected from the group consisting of hydroperoxide oxidants, ketone peroxide oxidants, and diacyl peroxide oxidants.

Specific embodiment 7 is the two-component thermally conductive adhesive composition according to Embodiment 6, wherein when a hydroperoxide oxidant or a ketone peroxide oxidant is employed as the peroxide oxidant, the peroxide decomposition promoter is one or more peroxide decomposition promotors selected from the group consisting of an organic acid metal salt peroxide decomposition promoter, an organometallic chelate peroxide decomposition promoter, a thiourea peroxide decomposition promoter.

Specific embodiment 8 is the two-component thermally conductive adhesive composition according to Embodiment 6, wherein when a diacyl peroxide oxidant is employed as the peroxide oxidant, the peroxide decomposition promoter is an amine peroxide decomposition promoter.

Specific embodiment 9 is the two-component thermally conductive adhesive composition according to Embodiment 1, where the thermally conductive filler is an inorganic thermally conductive filler.

Specific embodiment 10 is the two-component thermally conductive adhesive composition according to Embodiment 9, where the inorganic thermally conductive filler is one or more compounds selected from the group consisting of aluminum hydroxide, aluminum oxide, aluminum nitride, and boron nitride.

Specific embodiment 11 is the two-component thermally conductive adhesive composition according to Embodiment 9, where the inorganic thermally conductive filler has an average particle diameter in the range of 1-130 μm.

Specific embodiment 12 is the two-component thermally conductive adhesive composition according to Embodiment 1, where the acrylate monomer, or the combination of an acrylate monomer and an acrylate oligomer, and the thermally conductive filler exist in the Part A and the Part B at the same time.

Specific embodiment 13 is the two-component thermally conductive adhesive composition according to Embodiment 1, where the mass ratio of the Part A to the Part B is in the range of 1:10-10:1.

Specific embodiment 14 is the two-component thermally conductive adhesive composition according to Embodiment 1, where the mass ratio of the Part A to the Part B is 1:1.

Specific embodiment 15 is a two-component thermally conductive gap-filling glue, comprising the two-component thermally conductive adhesive composition according to any of Embodiments 1 to 14.

The present invention will be described below in more details in combination with embodiments. It needs to be pointed out that these descriptions and embodiments are all intended to make the invention easy to understand, rather than to limit the invention. The protection scope of the present invention is subject to the appended claims.

### Embodiments

In the present invention, unless otherwise pointed out, the reagents employed are all commercially available products, which are directly used without further purification.

TABLE 1
List of raw materials

| Compo- | | Product | |
|---|---|---|---|
| nent | Chemical Name | name | Supplier |
| Acrylate | Heptadecyl acrylate | C17A | BASF SE |
| monomer | Tg: −72° C. | | (Germany) |
| | Tetrahydrofurfuran | SR285 | Sartomer |
| | acrylate | | (China) |
| | Tg: −15° C. | | |
| | Ethoxylated bisphenol | SR480 | Sartomer |
| | A methacrylate | | (China) |
| | Tg: −1° C. | | |
| Acrylate | Aliphatic polyurethane | CN8888 | Sartomer |
| oligomer | acrylate oligomer | | (China) |
| | Tg: −32° C.; number | | |
| | average molecular | | |
| | weight: 6,000-8,000 g/mol | | |
| | Aliphatic polyurethane | CN9021 | Sartomer |
| | acrylate oligomer | | (China) |
| | Tg: −54° C.; number | | |
| | average molecular | | |
| | weight: 5,000-6,000 g/mol | | |
| | Aliphatic polyurethane | CN8881 | Sartomer |
| | acrylate oligomer | | (China) |
| | Tg: −3° C.; number | | |
| | average molecular | | |
| | weight: 2,800-3,600 g/mol | | |
| Peroxide | Benzoyl peroxide | BM-50R | Akzo Nobel |
| oxidant | | | (China) |
| Peroxide | N,N-dimethyl-p-toluidine | | Sigma-Aldrich |
| decompo- | | | (China) |
| sition | | | |
| promoter | | | |
| Thermally | Aluminum oxide | MARTOXID | Huber |
| conductive | Dv50: ~1.6 μm | TM-1250 | (Martinswerk) |
| filler | | | (China) |
| | Aluminum oxide | BAK-10 | Bestry High-tech |
| | Dv50: ~10.03 μm | | Materials |
| | | | Company |
| | Aluminum hydroxide | MoldX A110 | Huber (US) |
| | Dv50: ~10 μm | | |

* The medium particle size (average particle diameter) of thermally conductive filler, Dv50, is provided by supplier.

### Testing Method

### Polymer Molecular Weight (Number Average Molecular Weight Mn) Test:

Sample preparation and test method: A sample is dissolved at a concentration of 20 mg/4 ml in a tetrahydrofuran standard solution. After gently shaken to accelerate the dissolution, the sample is kept overnight to ensure the dissolution.

Test conditions—equipment: Waters 2695-MALS; chromatographic column: Jordi-DVB 30 cm×7.8 mm; column temperature: 40° C.: solvent: a tetrahydrofuran standard solution; flow rate: 1.0 ml/min: injected sample volume: 40 μl: test: Refractive Index: standard sample: polystyrene.

### Bonding Strength

The cured products obtained after curing of the two-component thermally conductive adhesive compositions obtained in the following embodiments and comparative examples were tested for the property of shear strength, according to the following method, so as to evaluate the bonding performance thereof.

Separately, Part A and Part B of the two-component thermally conductive adhesive composition prepared in the following embodiments and comparative examples were uniformly mixed, to obtain a gap-filling glue mixture. Two aluminum plates with a dimension of 101.6 mm (long) by 25.4 mm (wide) by 4 mm (thick) were taken, wiped clean with isopropanol on the surface and dried at room temperature. The two aluminum plates were overlapped in an overlaying mode of 25.4 mm (wide) by 12.7 mm (long) from respective ends, where 0.1 g of the above gap-filling glue mixture was clamped between the overlapping areas of the two aluminum plates. Then, the aluminum plates overlapped to the gap-filling glue mixture were kept at room temperature for 24 hours.

The shear strength (in MPa) was tested at room temperature (22-24° C.) at a crosshead pulling speed of 2.54 mm/min according to the dynamic shear test standard ASTM D1002-72 with the Instron 5969 device produced by Instron Inc., US.

### Thermal Conductivity

Thermal conductivity testing was carried out with an Analysis Tech thermal conductivity tester according to ASTM D5470. In particular, Part A and Part B of the two-component thermally conductive adhesive compositions prepared in the following embodiments and comparative examples were uniformly mixed, to obtain gap-filling glue mixtures. The gap-filling glue mixture was then pressed into a sample with a 6-cm diameter and a 1-mm thickness. The sample was cured at 23+2ºC for 24 hours to obtain a specimen. Then the specimen was cut into 3 discs with a knife die having a diameter of 33 mm. The thermal resistance of the 1-, 2-, and 3-ply discs was measured respectively with the thermal conductivity tester, at a condition of 50 psi pressure and 50° C. temperature. A straight line was fitted, and the thermal conductivity was calculated (in W/K*m).

### Elongation-at-Break

The elongation-at-break was measured according to ASTM D638 with an Instron 5969 tensile tester manufactured by Instron Corp., US. In particular, Part A and Part B of the two-component thermally conductive adhesive compositions prepared in the following embodiments and comparative examples were uniformly mixed, to obtain gap-filling glue mixtures. Then the gap-filling glue mixture was pressed into a dog bone-shaped sample with a thickness of 3 mm. The sample was cured at 23+2ºC for 24 hours to obtain a specimen. Then the specimen was subjected to tensile testing at a tensile speed of 50 mm/min with the Instron 5969 tensile tester.

### Embodiment 1 (E1)

A two-component thermally conductive adhesive composition 1 was prepared in Embodiment 1. The two-component thermally conductive adhesive composition 1 comprises Part A and Part B that were independent of each other. The preparation of Part A included uniformly mixing 4.0 g of a peroxide oxidant (BPO: benzoyl peroxide), 16.0 g of an acrylate monomer C17A (heptadecyl acrylate), 20.0 g of an acrylate oligomer (CN9021), and 60.0 g of a thermally conductive filler (aluminum hydroxide MAX110) according to the blending ratio in Table 2 shown below. The preparation of Part B included uniformly mixing 0.5 g of a peroxide oxidant decomposition promoter (N,N-dimethyl-p-toluidine), 15.5 g of an acrylate monomer C17A (heptadecyl acrylate), 24.0 g of an acrylate oligomer (CN9021), and 60.0 g of a thermally conductive filler (aluminum hydroxide MAX110) according to the blending ratio in Table 2 shown below.

The two-component thermally conductive adhesive composition 1 obtained according to the above steps was tested, according to the methods described in detail above regarding the bonding strength, thermal conductivity, and elongation-at-break tests. The resulting test results are shown in Table 2.

### Embodiments 2-9 (E2-E9) and Comparative Examples 1-2 (C1-C2)

Two-component thermally conductive adhesive compositions 2-9 and comparative two-component thermally conductive adhesive compositions 1-2 were prepared respectively in a manner similar to Embodiment 1, in accordance with the blending ratio in Table 2 shown below.

The two-component thermally conductive adhesive compositions 2-9 and comparative two-component thermally conductive adhesive compositions 1-2 obtained according to the above steps were tested, according to the methods described in detail above regarding the bonding strength, thermal conductivity, and elongation-at-break tests. The resulting test results are shown in Table 2.

TABLE 2
Component ratio and performance test of two-component thermally conductive adhesive compositions

| | | Embodiments or Comparative examples | | | | | | | | | | |
|---|---|---|---|---|---|---|---|---|---|---|---|---|
| | | E1 | E2 | E3 | E4 | E5 | E6 | E7 | E8 | E9 | C1 | C2 |
| Part A | BPO (Oxidant) | 4.0 | 1.0 | 1.0 | 1.4 | 0.4 | 1.2 | 1.0 | 1.0 | 1.0 | 1.2 | 1 |
| | C17A (Tg: −72° C.) | 16.0 | 24.0 | 20.0 | 15.6 | 8.6 | 23.1 | 22.5 | 20.0 | 8.0 | | |
| | SR285 (Tg: −15° C.) | | | | 1.0 | | 4.7 | | | | | |
| | SR480 (Tg: −1° C.) | | | | | | | | | | 27.8 | 22.5 |
| | CN8888 (Tg: −32° C.) | | 1.0 | | | | | 5.0 | | 1.0 | | |
| | CN9021 (Tg: −54° C.) | 20.0 | | 5.0 | 4.0 | 1.0 | | | 5.0 | | | |
| | CN8881 (Tg: −3° C.) | | | | | | | | | | | 5 |
| | TM1250 (Thermally conductive filler) | | | | 32.0 | 5.0 | | | | | | |
| | BAK10 (Thermally conductive filler) | | | | | 85.0 | | | | | | |
| | MAX110 (Thermally conductive filler) | 60.0 | 74.0 | 74.0 | 46.0 | | 71.0 | 71.5 | 74.0 | 90 | 71 | 71.5 |
| Total amount (g) | | 100 | 100 | 100 | 100 | 100 | 100 | 100 | 100 | 100 | 100 | 100 |
| Part B | N,N-dimethyl-p-toluidine | 0.5 | 0.1 | 0.2 | 0.3 | 0.2 | 2 | 0.1 | 1.0 | 0.5 | 0.2 | 0.1 |
| | (decomposition promoter) | | | | | | | | | | | |
| | C17A (Tg: −72° C.) | 15.5 | 22.9 | 18.8 | 13.4 | 8.8 | 20.2 | 20.5 | 8.0 | 20.5 | | |
| | SR285 (Tg: −15° C.) | | | | 1.0 | | 4.8 | | | | | |
| | SR480 (Tg: −1° C.) | | | | | | | | | | 26.8 | 20.5 |
| | CN8888 (Tg: −32° C.) | | 1.0 | | | | | 5.0 | | 1.0 | | |
| | CN9021 (Tg: −54° C.) | 24.0 | | 5.0 | 4.3 | 1.0 | | | 1.0 | | | |
| | CN8881 (Tg: −3° C.) | | | | | | | | | | | 5 |
| | TM1250 (Thermally conductive filler) | | | | 32.6 | 10.0 | | | | | | |
| | BAK10 (Thermally conductive filler) | | | | | 80.0 | | | | | | |
| | MAX110 (Thermally conductive filler) | 60.0 | 76.0 | 76.0 | 48.4 | | 73.0 | 74.4 | 90 | 78.0 | 73 | 74.4 |

| | | | | | | | | | | | |
|---|---|---|---|---|---|---|---|---|---|---|---|
| Total amount (g) | 100 | 100 | 100 | 100 | 100 | 100 | 100 | 100 | 100 | 100 | 100 |

Performance test results

| | | | | | | | | | | | |
|---|---|---|---|---|---|---|---|---|---|---|---|
| Bonding strength (MPa) | 0.22 | 0.13 | 0.2 | 0.3 | 0.15 | 0.11 | 0.23 | 0.25 | 0.18 | 1.5 | 1.9 |
| Thermal conductivity (W/K*m) | 0.7 | 1.2 | 1.2 | 1.4 | 2.1 | 1.0 | 1.1 | 0.9 | 1.0 | 1.0 | 1.1 |
| Elongation-at-break (%) | 390 | 220 | 238 | 185 | 172 | 184 | 90 | 250 | 160 | 4 | 6 |

As can be seen from the results shown in Table 2 above, when each component and the specific content thereof are selected from the range according to the present invention, the cured products of the resulting two-component thermally conductive adhesive compositions have a high elongation-at-break, high thermal conductivity and low bonding strength to aluminum metal surfaces, and are suitable to be used as a thermally conductive gap-filling material in battery pack modules of electric vehicles. The cured products of the two-component thermally conductive adhesive composition prepared in Embodiments 1-9 all had bonding strength of less than 0.5 MPa and were easy to remove. The products of Embodiments 1-9 all had an elongation-at-break of greater than 50%. Preferred Embodiments 1-6 and Embodiments 8-9 all had an elongation-at-break of greater than 100%, mainly due to the use of a lower-Tg polyacrylate monomer in the formulation.

Furthermore, as can be known from the results of Comparative examples 1 and 2 shown in Table 2 that, when an acrylate monomer or an acrylate oligomer with a glass transition temperature out of the range of −80° C. to −10° C. is employed, the resulting cured product had greater bonding strength (e.g., greater than or equal to 1.5 MPa) to aluminum metal surfaces and a quite low elongation-at-break (e.g., less than or equal to 6%), which could not meet the requirements.

1. A two-component thermally conductive adhesive composition, based on the weight of the two-component thermally conductive adhesive composition as 100 wt %, comprising:
8-38 wt % of an acrylate monomer or a combination of an acrylate monomer and an acrylate oligomer, with a glass transition temperature ranging from −80° C. to −10° C.;
0.2-4 wt % of a peroxide oxidant;
0.05-1 wt % of a peroxide decomposition promoter; and
60-90 wt % of a thermally conductive filler, wherein
the two-component thermally conductive adhesive composition comprises Part A and Part B, the Part A comprises the peroxide oxidant and the Part B comprises the peroxide decomposition promoter; the acrylate monomer, or the combination of the acrylate monomer and the acrylate oligomer, and the thermally conductive filler exist in one or both of the Part A and Part B.

2. The two-component thermally conductive adhesive composition according to claim 1, wherein the acrylate monomer is an acrylate monomer having 7-27 carbon atoms.

3. The two-component thermally conductive adhesive composition according to claim 1, wherein the acrylate monomer is selected from the group consisting of heptadecyl acrylate, tetrahydrofuran acrylate, lauryl methacrylate, isodecyl acrylate, octyl acrylate, isooctyl acrylate, tridecyl acrylate, dodecyl acrylate, dodecyl methacrylate, methoxypolyethylene glycol monomethacrylate, methoxypolyethylene glycol monoacrylate, alkoxydodecyl acrylate, 2-(2-ethoxyethoxy)ethyl acrylate, tetrahydrofuran alkoxide acrylate, or a combination thereof.

4. The two-component thermally conductive adhesive composition according to claim 1, wherein the acrylate oligomer is an aliphatic urethane acrylate oligomer.

5. The two-component thermally conductive adhesive composition according to claim 4, wherein the aliphatic urethane acrylate oligomer has a number average molecular weight ranging from 5,000 g/mol to 8,000 g/mol.

6. The two-component thermally conductive adhesive composition according to claim 1, wherein the peroxide oxidant is one or more peroxide oxidants selected from the group consisting of hydroperoxide oxidants, ketone peroxide oxidants, and diacyl peroxide oxidants.

7. The two-component thermally conductive adhesive composition according to claim 6, wherein when a hydroperoxide oxidant or a ketone peroxide oxidant is employed as the peroxide oxidant, the peroxide decomposition promoter is one or more peroxide decomposition promoters selected from the group consisting of an organic acid metal salt peroxide decomposition promoter, an organometallic chelate peroxide decomposition promoter, a thiourea peroxide decomposition promoter.

8. The two-component thermally conductive adhesive composition according to claim 6, wherein when a diacyl peroxide oxidant is employed as the peroxide oxidant, the peroxide decomposition promoter is an amine peroxide decomposition promoter.

9. The two-component thermally conductive adhesive composition according to claim 1, wherein the thermally conductive filler is an inorganic thermally conductive material.

10. The two-component thermally conductive adhesive composition according to claim 9, wherein the inorganic thermally conductive filler is one or more compounds selected from the group consisting of aluminum hydroxide, aluminum oxide, aluminum nitride, and boron nitride.

11. The two-component thermally conductive adhesive composition according to claim 9, wherein the inorganic thermally conductive filler has an average particle diameter ranging from 1 to 130 μm.

12. The two-component thermally conductive adhesive composition according to claim 1, wherein the acrylate monomer, or the combination of an acrylate monomer and an acrylate oligomer, and the thermally conductive filler exist in the Part A and the Part B at the same time.

13. The two-component thermally conductive adhesive composition according to claim 1, wherein the mass ratio of the Part A to the Part B is in the range of 1:10-10:1.

14. The two-component thermally conductive adhesive composition according to claim 1, wherein the mass ratio of the Part A to the Part B is 1:1.

15. A two-component thermally conductive gap-filling glue, comprising the two-component thermally conductive adhesive composition according to claim 1.
